(19) United States
(12) Patent Application Publication
(10) Pub. No.: US 2026/0302603 A1
(43) Pub. Date: Oct. 1, 2026

(54) ANTENNA DEVICE AND VEHICLE-MOUNTED ANTENNA DEVICE

(71) Applicant: Auo Corporation, Hsinchu City (TW)

(72) Inventors: Jhih-Jhu JHAN, Hsinchu City (TW); Shuo-Yang SUN, Hsinchu City (TW); Chun CHANG, Hsinchu City (TW); Fu- Yang CHEN, Hsinchu City (TW); Shih-Hsien YANG, Hsinchu City (TW); Hao-Lun HSIEH, Hsinchu City (TW); Xiao-Yun LI, Hsinchu City (TW); Yu-Hao CHANG, Hsinchu City (TW)

(21) Appl. No.: 19/384,029

(22) Filed: Nov. 10, 2025

(30) Foreign Application Priority Data
Mar. 31, 2025 (TW) 114112456

(51) Int. Cl. H01Q 1/42; H01Q 1/32; H01Q 9/04; H01Q 21/06

(52) U.S. Cl. CPC H01Q 1/422; H01Q 9/0407; H01Q 21/065; H01Q 1/32

(57) ABSTRACT

An antenna device and a vehicle-mounted antenna device are provided. The antenna device includes a first outer substrate, a second outer substrate, an antenna module, a first outer support structure, and a second outer support structure. The antenna module is located between the first outer substrate and the second outer substrate and includes an inner substrate and an antenna structure. The antenna structure is disposed on the inner substrate. The first outer support structure is disposed between the antenna module and the first outer substrate, and the second outer support structure is disposed between the antenna module and the second outer substrate. There are gaps between the antenna module and the first outer substrate and between the antenna module and the second outer substrate. An orthogonal projection of the first outer support structure and an orthogonal projection of the second outer support structure overlap at least partially.

### CROSS-REFERENCE TO RELATED APPLICATION

This application claims priority to Taiwan Application Serial Number 114112456, filed Mar. 31, 2025. The above-mentioned patent application is herein incorporated by reference in its entirety.

### BACKGROUND

### Technical Field

The present disclosure relates to an antenna device and a vehicle-mounted antenna device.

### Description of Related Art

Antennas have been widely used in vehicle bodies, for example, for navigation, autonomous driving, vehicle tracking, communications, or interconnection with devices inside/outside vehicle bodies. Currently, antennas integrated with vehicle windows have been developed, which not only enhance the appearance of vehicle bodies, but also reduce shielding effects of metal vehicle bodies and improve stability of signals since vehicle windows are made of highly light-transmissive materials. Therefore, antennas integrated with vehicle windows can also support high-frequency millimeter-wave or low-orbit satellite communications.

However, for antennas integrated with vehicle windows, it is still necessary to consider how to improve the radiation efficiency and the manufacturing yield.

### SUMMARY

At least one embodiment of the present disclosure provides an antenna device and a vehicle-mounted antenna device using the same.

The antenna device provided in the at least one embodiment of the present disclosure comprises a first outer substrate, a second outer substrate, an antenna module, a first outer support structure, and a second outer support structure. The antenna module is located between the first outer substrate and the second outer substrate. The antenna module comprises a first inner substrate and a first antenna structure. The first inner substrate has a surface. The first antenna structure is disposed on the surface. The first outer support structure is disposed between the antenna module and the first outer substrate. At least one first gap exists between the antenna module and the first outer substrate. The second outer support structure is disposed between the antenna module and the second outer substrate. At least one second gap exists between the antenna module and the second outer substrate. An orthogonal projection of the first outer support structure on the first inner substrate and an orthogonal projection of the second outer support structure on the first inner substrate overlap at least partially.

In the at least one embodiment of the present disclosure, the first outer support structure has a first opening. The second outer support structure has a second opening. The first opening is in communication with the at least one first gap, and an orthogonal projection of the first opening on the first inner substrate overlaps with an orthogonal projection of the first antenna structure on the first inner substrate. The second opening is in communication with the at least one second gap, and an orthogonal projection of the second opening on the first inner substrate overlaps with the orthogonal projection of the first antenna structure on the first inner substrate.

In the at least one embodiment of the present disclosure, the orthogonal projection of the first outer support structure on the first inner substrate has a first projected area. The orthogonal projection of the second outer support structure on the first inner substrate has a second projected area. The surface has a reference area. A ratio of each of the first projected area and the second projected area to the reference area is greater than or equal to 60%.

In the at least one embodiment of the present disclosure, the first antenna structure occupies a region of the surface, and the region has an antenna area. The ratio of the first projected area to the reference area, and the ratio of the second projected area to the reference area, satisfy the following ranges, respectively: R₁≤(A_{bass}−Aₐₙₜₑₙₙₐ)/A_{bass}; and R₂≤(A_{bass}−Aₐₙₜₑₙₙₐ)/A_{bass}. R₁ represents the ratio of the first projected area to the reference area. R₂ represents the ratio of the second projected area to the reference area. A_{bass} represents the reference area. Aₐₙₜₑₙₙₐ represents the antenna area.

In the at least one embodiment of the present disclosure, the ratio of each of the first projected area and the second projected area to the reference area is less than or equal to 75%.

In the at least one embodiment of the present disclosure, the antenna module further comprises a second inner substrate, a second antenna structure, and an inner support structure. The second inner substrate is spaced apart from the first inner substrate. The first antenna structure is located between the first inner substrate and the second inner substrate. The second antenna structure is disposed on the second inner substrate. The second inner substrate is located between the first antenna structure and the second antenna structure, and an orthogonal projection of the second antenna structure on the first inner substrate overlaps with an orthogonal projection of the first antenna structure on the first inner substrate. The inner support structure is disposed between the first inner substrate and the second inner substrate. An orthogonal projection of the inner support structure on the first inner substrate overlaps at least in part with the orthogonal projection of the first outer support structure on the first inner substrate.

In the at least one embodiment of the present disclosure, the orthogonal projection of the inner support structure on the first inner substrate has a third projected area. The surface has a reference area. A ratio of the third projected area to the reference area is greater than or equal to 37%.

In the at least one embodiment of the present disclosure, the first antenna structure occupies a region of the surface, and the region has an antenna area. The ratio of the third projected area to the reference area satisfies the following range: R₃≤(A_{bass}−Aₐₙₜₑₙₙₐ)/A_{bass}. R₃ represents the ratio of the third projected area to the reference area. A_{bass} represents the reference area. Aₐₙₜₑₙₙₐ represents the antenna area.

In the at least one embodiment of the present disclosure, a Young's modulus of each of the first outer substrate, the second outer substrate, the first inner substrate, and the second inner substrate is greater than a Young's modulus of each of the first outer support structure, the second outer support structure, and the inner support structure. The Young's modulus of each of the first outer support structure and the second outer support structure is greater than or equal to the Young's modulus of the inner support structure.

In the at least one embodiment of the present disclosure, a first distance exists between the first inner substrate and the first outer substrate. A second distance exists between the first inner substrate and the second inner substrate. The first distance is greater than the second distance.

The vehicle-mounted antenna device provided in the at least one embodiment of the present disclosure comprises the above antenna device. The antenna device is integrated with a vehicle window of a vehicle body.

Based on the above, in the antenna device and the vehicle-mounted antenna device disclosed in the above embodiments, the first outer support structure and the second outer support structure can be respectively disposed between the antenna module and the first outer substrate, and between the antenna module and the second outer substrate, so that there is air with appropriate thicknesses between the antenna module and the first outer substrate, and between the antenna module and the second outer substrate. The antenna device can further achieve the effects of wide bandwidth, good antenna radiation efficiency, and reduced loss.

### BRIEF DESCRIPTION OF THE DRAWINGS

For a more complete understanding of embodiments and their advantages, reference is now made to the following description taken in conjunction with the drawings, in which:

FIG. 1 is a schematic top view of an antenna device integrated with a vehicle window according to at least one embodiment of the present disclosure;

FIG. 2 is a cross-sectional view taken along line A-A′ in FIG. 1;

FIG. 3 is a schematic exploded perspective view depicting assembly of the antenna device of FIG. 1;

FIG. 4 is a schematic top view of an antenna device integrated with a vehicle window according to another embodiment of the present disclosure;

FIG. 5 is a cross-sectional view taken along line B-B′ in FIG. 4;

FIG. 6 is a schematic exploded perspective view depicting assembly of the antenna device of FIG. 4;

FIGS. 7A and 7B respectively show simulation results of S11 parameters and gains for the antenna device with different dimensions of gaps; and

FIG. 8 is a cross-sectional view of the antenna device according to another embodiment of the present disclosure.

### DETAILED DESCRIPTION

For clearly introducing the technical features of the present application below, the dimensions (such as length, width, thickness, and depth) of components (such as layers, membranes, substrates, and areas) in the figures will be scaled up disproportionately, and the number of some components will be reduced. Accordingly, the description and interpretation of the embodiments below shall not be limited to the number of components and the dimensions and shapes of the components shown in the figures, but shall encompass dimensions, shapes and deviations therebetween as a result of actual manufacturing processes and/or tolerances. For example, a flat surface shown in a figure may have a feature of roughness and/or nonlinearity, while an acute angle shown in a figure may be circular. Therefore, the components shown in the figures of the present application are mainly used for schematic purposes, and are not intended to accurately depict the actual shapes of the components, nor are they used to limit the claims of the patent application.

Secondly, the words “about”, “approximately” or “substantially” appearing herein encompass not only clearly recorded values and ranges of values, but also allowable deviation ranges understood by persons of ordinary skill in the art, in which the deviation ranges may be determined by errors resulting from measurements, and the errors are due, for example, to limitations of both a measuring system and process conditions. For example, two objects (such as a plane or a trace of a substrate) are “substantially parallel” or “substantially vertical”, where “substantially parallel” and “substantially vertical” respectively represent that the parallelism and perpendicularity between the two objects may contain non-parallelism and non-perpendicularity caused by the allowable deviation ranges.

In addition, the word “about” can mean within one or more standard deviations of the above values, such as ±30%, ±20%, ±10% or ±5%. The terms “about”, “approximately” or “substantially” and the like used in the present application may be used to select acceptable deviation ranges or standard deviations based on optical, etchable, mechanical or other properties, rather than a single standard deviation to apply all of the above optical, etchable, mechanical or other properties.

Spatially relative terms used in the present disclosure, such as “under”, “below”, “above”, “over”, are used to facilitate the description of a relative relationship between one component or feature and another component or feature, as shown in the figures. The real meaning of the spatially relative terms involves other orientations. For example, when turning upside down and downside up at 180 degrees, the relationship between one component and another may change from “under” and “below” to “above” and “over”. In addition, spatially relative statements used in the present disclosure shall be similarly interpreted.

In addition, the present disclosure may be implemented or applied by means of other different specific embodiments, the details of the present disclosure may be based on different viewpoints and applications, and various embodiments can be combined, modified and changed without deviating from the idea of the present disclosure. To clearly describe the following embodiments, components with the same or similar functions are denoted by the same reference numerals.

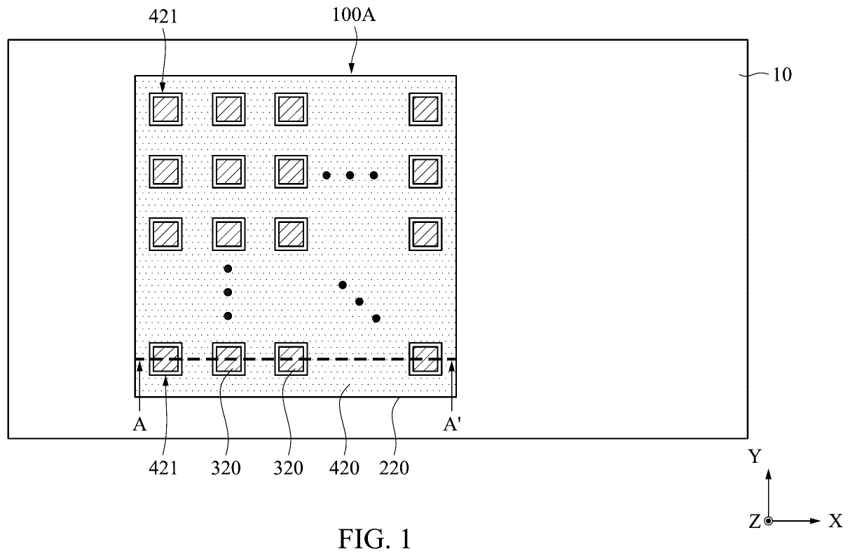

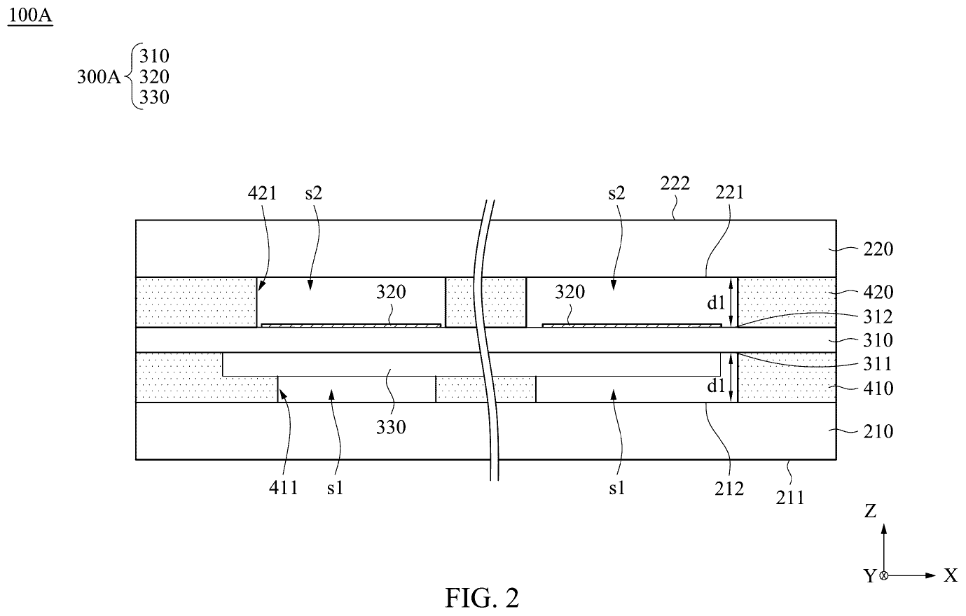

FIG. 1 is a schematic top view of an antenna device 100A integrated with a vehicle window 10 according to at least one embodiment of the present disclosure. FIG. 2 is a cross-sectional view taken along line A-A′ in FIG. 1. Referring to FIGS. 1 and 2, the antenna device 100A includes outer substrates 210, 220, an antenna module 300A and outer support structures 410, 420. For example, the antenna device 100A may be integrated with a vehicle body, for example, with a vehicle window 10 of the vehicle body (not shown) to form a vehicle-mounted antenna device, but is not limited thereto. In other embodiments, the antenna device 100A may be integrated into the vehicle body or disposed on an outer shell of the vehicle body. In other embodiments, the antenna device 100A may be integrated with a window of a building, or with other suitable structures. It should be noted that in FIG. 1, for clarity of illustrating the configuration of the antenna module 300A and the outer support structure 420, structures of the antenna module 300A and the outer support structure 420 covered by the outer substrate 220 are still depicted with solid lines.

The outer substrate 210 (first outer substrate) has a surface 211 and a surface 212 opposite each other in a direction Z. The outer substrate 220 (second outer substrate) is spaced apart from the outer substrate 210, and has a surface 221 and a surface 222 opposite each other in the direction Z. The surface 212 of the outer substrate 210 and the surface 221 of the outer substrate 220 face each other, and the areas of the surfaces 211, 212, 221, 222 are the same. The material of the outer substrates 210, 220 may be glass or other materials with light transmittance and sufficient supporting strength.

The antenna module 300A is located between the outer substrates 210 and 220. The antenna module 300A may include an inner substrate 310 (first inner substrate), a plurality of antenna structures 320 (first antenna structures), and a redistribution layer structure 330. The inner substrate 310 has a surface 311 and a surface 312 opposite each other in the direction Z. The surface 311 of the inner substrate 310 faces the surface 212 of the outer substrate 210. The surface 312 of the inner substrate 310 faces the surface 221 of the outer substrate 220, and the areas of the surfaces 311, 312 are the same as the areas of the surfaces 212, 221. The material of the inner substrate 310 may also be glass or other materials with light transmittance and sufficient supporting strength.

The plurality of antenna structures 320 are disposed on the surface 312 of the inner substrate 310 at intervals and may be arranged along a direction X and a direction Y to form an array. For example, the antenna structure 320 may be a metal plate body such as a patch antenna. The shape of the antenna structure 320 may be approximately rectangular, but is not limited thereto. In other embodiments, the antenna structure 320 may also be circular, triangular, annular, or polygonal in shape. It should be noted that for the examples of FIGS. 1 and 2, the antenna module 300A includes the plurality of antenna structures 320, but is not limited thereto. In other embodiments, the antenna module may include only one antenna structure 320.

The redistribution layer structure 330 is disposed on the surface 311 of the inner substrate 310. An electronic component (not shown), such as a chip, may be electrically connected to a pad of an outer wiring layer of the redistribution layer structure 330. The chip may provide a feed signal to the redistribution layer structure 330, and energy of the feed signal may be coupled to the plurality of antenna structures 320, so that the antenna device 100A radiates electromagnetic waves. For example, the antenna device 100A may operate in a Ka-band (26.5 GHz-40 GHz).

The outer support structure 410 (first outer support structure) may be disposed between the antenna module 300A and the outer substrate 210, so that at least one gap s1 (first gap) exists between the antenna module 300A and the outer substrate 210. On the other hand, the outer support structure 420 (second outer support structure) may be disposed between the antenna module 300A and the outer substrate 220, so that at least one gap s2 (second gap) exists between the antenna module 300A and the outer substrate 220. As shown in FIG. 2, a plurality of gaps s1 and a plurality of gaps s2 exist between the antenna module 300A and the outer substrates 210 and 220, respectively. Further, an orthogonal projection of the outer support structure 410 on the inner substrate 310 and an orthogonal projection of the outer support structure 420 on the inner substrate 310 overlap at least partially.

In detail, the outer support structure 410 has a plurality of openings 411 (first openings), and the openings 411 are respectively in communication with the plurality of gaps s1. Orthogonal projections of the openings 411 on the inner substrate 310 overlap with orthogonal projections of the plurality of antenna structures 320 on the inner substrate 310, respectively. The outer support structure 420 also has a plurality of openings 421 (second openings), and the openings 421 are respectively in communication with the plurality of gaps s2. Orthogonal projections of the openings 421 on the inner substrate 310 also overlap at least in part with the orthogonal projections of the plurality of antenna structures 320 on the inner substrate 310, respectively.

That is to say, the antenna structures 320 are located in the openings 421, respectively. The antenna structures 320 may be surrounded by the outer support structure 420 and exposed through the openings 421. Therefore, the antenna structures 320 are not covered by the outer support structure 420 and can maintain gaps s2 with the outer substrate 220. Since the orthogonal projections of the outer support structures 410 and 420 on the inner substrate 310 overlap at least partially, the antenna module 300A can be firmly supported by the outer support structures 410 and 420. Additionally, the redistribution layer structure 330 is also exposed through the openings 411 and not entirely covered by the outer support structure 410. Therefore, the redistribution layer structure 330 can maintain gaps s1 with the outer substrate 210, so that the outer support structure 410 does not interfere with signal transmission of the redistribution layer structure 330.

It should be noted that the antenna device 100A may be integrated with the vehicle window 10 of the vehicle body by bonding via at least one of the outer substrates 210, 220 and the outer support structures 410, 420. Alternatively, the outer substrates 210, 220 may respectively be parts of two layers of glass of the vehicle window 10, without limitation. When the antenna device 100A is integrated with the vehicle window 10 (e.g., a sunroof), the surface 211 of the outer substrate 210 may face the interior of the vehicle body, while the surface 222 of the outer substrate 220 may face the exterior of the vehicle body.

The material of the outer support structures 410, 420 may be polyvinyl butyral (PVB). Specifically, Young's moduli of the outer substrates 210, 220 and the inner substrate 310 may range from 60 GPa to 90 GPa (gigapascals). Young's moduli of the outer support structures 410 and 420 may range from 2 GPa to 5 GPa. Although the Young's moduli of the outer support structures 410 and 420 are less than the Young's moduli of the outer substrates 210, 220 and the inner substrate 310, the outer support structures 410, 420 offer advantages such as impact resistance, good encapsulation properties, and favorable bonding with the outer substrates 210, 220 and the inner substrate 310.

When the outer substrates 210, 220, the inner substrate 310 and the outer support structures 410 and 420 are combined (thermal compression process), the outer support structures 410 and 420 can absorb energy, thereby reducing the risk of fracture in the outer substrates 210, 220 or the inner substrate 310.

Further, the surface 312 of the inner substrate 310 has a reference area. The orthogonal projection of the outer support structure 410 on the inner substrate 310 has a first projected area. The orthogonal projection of the outer support structure 420 on the inner substrate 310 has a second projected area. The plurality of antenna structures 320 occupy a region of the surface 312, and the region has an antenna area. A ratio R₁ of the first projected area to the reference area falls within the following range:
60%≤R₁≤(A_{bass}−Aₐₙₜₑₙₙₐ)/A_{bass};
where A_{bass} and Aₐₙₜₑₙₙₐ respectively represent the reference area and the antenna area.

Similarly, a ratio R₂ of the second projected area to the reference area falls within the following range:
60%≤R₂≤(A_{bass}−Aₐₙₜₑₙₙₐ)/A_{bass}

It should be noted that since the material of the outer support structures 410 and 420 is a soft material before heating and exhibits fluidity and ductility during the heating process, for example, the minimum limit values of the first projected area and the second projected area are greater than or equal to 60% of the reference area during the heating process. Further, since the outer support structures 410 and 420 need to be offset from the antenna structures 320 as much as possible, for example, the maximum limit values of the first projected area and the second projected area are less than or equal to the reference area minus the antenna area.

For example, if a ratio of the antenna area to the reference area is 21%, the ratio R₁ of the first projected area to the reference area or the ratio R₂ of the second projected area to the reference area may be less than or equal to 79%. In addition, if region reservation for positional alignment errors of the outer support structures 410, 420 is taken into account, the ratio R₁ of the first projected area to the reference area or the ratio R₂ of the second projected area to the reference area may be less than or equal to 75%.

It should be noted that, since the material of the outer support structures 410 and 420 exhibits fluidity and ductility during the heating process, even if the outer support structures 410 and 420 have the same structural dimensions before heating, their structural dimensions after heating may not necessarily be exactly the same. Therefore, the structural dimensions of the outer support structures 410, 420 may be the same or different, with no limitation imposed. It is sufficient that the ratio R₁ of the first projected area corresponding to the outer support structure 410 to the reference area and the ratio R₂ of the second projected area corresponding to the outer support structure 420 to the reference area fall within the aforementioned ranges.

It is worth mentioning that a distance d1 between the surface 311 of the inner substrate 310 and the surface 212 of the outer substrate 210 or a distance d1 between the surface 312 of the inner substrate 310 and the surface 221 of the outer substrate 220 may range from 2 millimeters to 10 millimeters, for example, from 4 millimeters to 5 millimeters. Since a dielectric constant of air is relatively low, there is air with appropriate thicknesses between the antenna module 300A and the outer substrate 210, and between the antenna module 300A and the outer substrate 220, so that the antenna device 100A can further achieve the effects of wide bandwidth, good antenna radiation efficiency, and reduced loss.

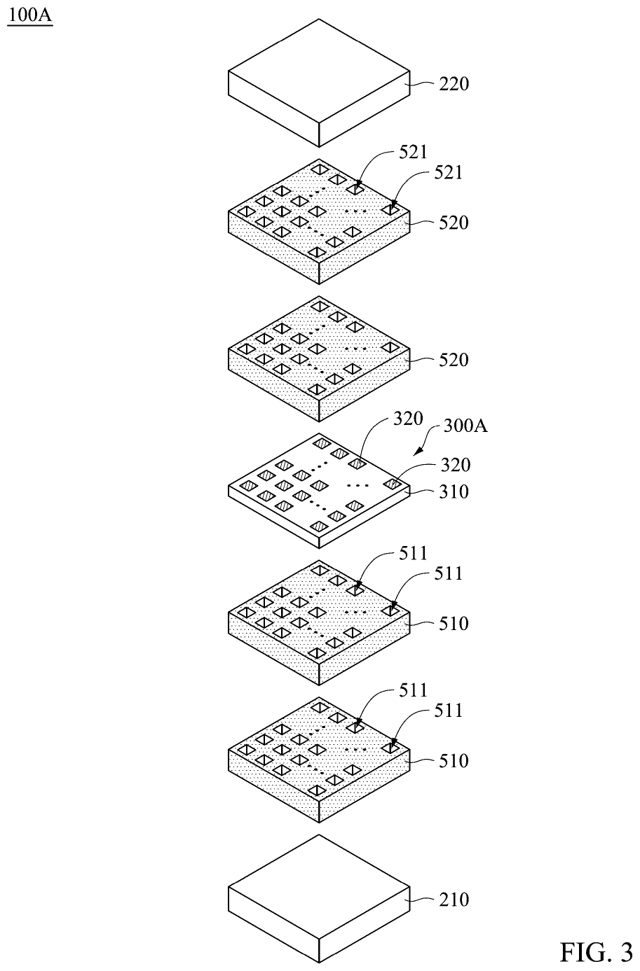

FIG. 3 is a schematic exploded perspective view depicting assembly of the antenna device 100A of FIG. 1. Referring to FIGS. 1 to 3, during the assembly of the antenna device 100A, a plurality of outer support materials 510, 520 are first patterned to form a plurality of openings 511 on each of the outer support material 510 and a plurality of openings 521 on each of the outer support material 520. Each of the outer support materials 510, 520 has a sheet-like shape. Subsequently, the plurality of outer support materials 510 are stacked between the outer substrate 210 and the inner substrate 310, where the plurality of openings 511 are respectively aligned with the back surfaces of the plurality of antenna structures 320 of the antenna module 300A. The plurality of outer support materials 520 are stacked between the outer substrate 220 and the inner substrate 310, where the plurality of openings 521 are respectively aligned with the plurality of antenna structures 320 of the antenna module 300A. The configurations of the openings 511 and 521 respectively correspond to the configurations of the antenna structures 320. The openings 511, 521 of the outer support materials 510, 520 are distributed in a mesh pattern, but are not limited thereto.

Thereafter, the outer substrates 210, 220, the antenna module 300A, and the plurality of outer support materials 510, 520 undergo a thermal compression process, so that the plurality of outer support materials 510, 520 respectively form the outer support structures 410, 420, and the plurality of openings 511, 521 respectively form the openings 411, 421, thereby completing the assembly of the antenna device 100A. It should be noted that for the examples of FIGS. 2 and 3, considering the thickness of the outer support structures 410, 420 in the direction Z, the outer support structure 410 may be fabricated from a plurality of outer support materials 510, and the outer support structure 420 may be fabricated from a plurality of outer support materials 520, but is not limited thereto. In other embodiments, the outer support structure 410 may be fabricated from a single outer support material 510, and the outer support structure 420 may be fabricated from a single outer support material 520.

It is worth mentioning that the plurality of outer support materials 510, 520 are soft materials before heating, and when heated to a specific temperature, molecular chains of the outer support materials 510, 520 begin to move. The outer support materials 510, 520 undergo structural reorganization, causing the molecular chains to be arranged more densely under the action of thermal energy, thereby enhancing the rigidity and Young's moduli of the outer support structures 410 and 420. Furthermore, due to the appropriate proportion of the outer support structures 410, 420 to the inner substrate 310, the antenna module 300A can be well-supported, thereby preventing the outer substrates 210, 220 or the inner substrate 310 from being damaged by lamination stress during the process. The manufacturing and assembly yields of the antenna device 100A are thus improved.

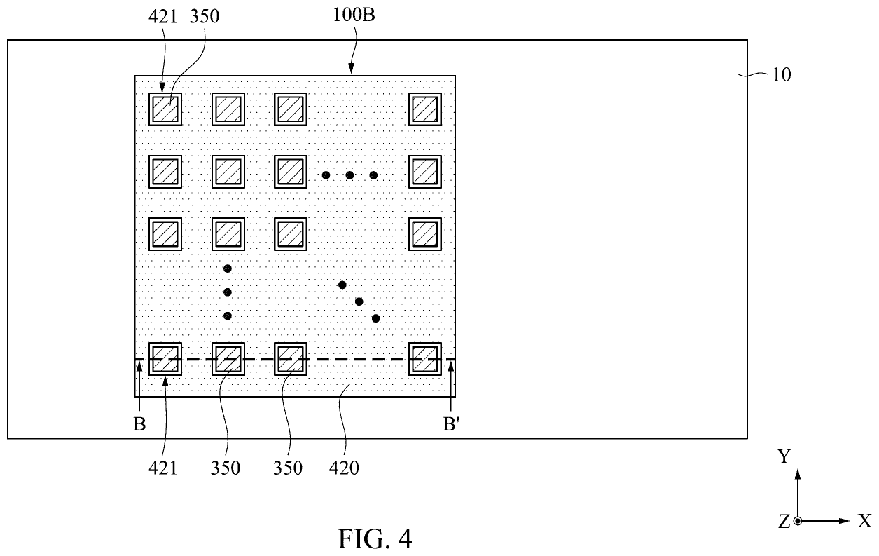

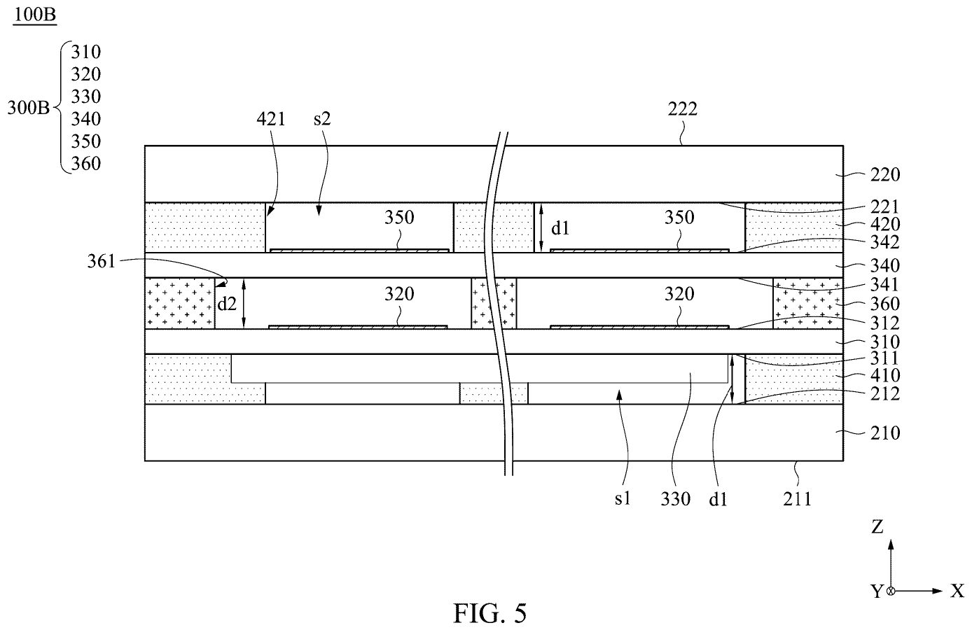

FIG. 4 is a schematic top view of an antenna device 100B integrated with a vehicle window 10 according to another embodiment of the present disclosure. FIG. 5 is a cross-sectional view taken along line B-B′ in FIG. 4. Referring to FIGS. 4 and 5, the antenna device 100B of FIG. 5 is similar to the antenna device 100A of FIG. 2. A difference between the two is that an antenna module 300B of the antenna device 100B further includes an inner substrate 340 (second inner substrate), a plurality of antenna structures 350 (second antenna structures), and an inner support structure 360, in addition to an inner substrate 310 (first inner substrate), a plurality of antenna structures 320 (first antenna structures), and a redistribution layer structure 330. It should be noted that in FIG. 4, for clarity of illustrating the configuration of the antenna module 300B and an outer support structure 420, structures of the antenna module 300B and the outer support structure 420 covered by the outer substrate 220 are still depicted with solid lines.

The inner substrate 340 is spaced apart from the inner substrate 310, the inner substrate 340 is disposed between the outer substrate 220 and the inner substrate 310, and the antenna structures 320 is located between the inner substrates 310 and 340. The inner substrate 340 has a surface 341 and a surface 342 opposite each other in a direction Z. The surface 341 of the inner substrate 340 faces the surface 312 of the inner substrate 310. The surface 342 of the inner substrate 340 faces the surface 221 of the outer substrate 220. In addition, the surfaces 211, 212, 221, 222, 311, 312, 341, and 342 each have the same area. The material of the inner substrate 340 is similar to that of the inner substrate 310, and may also be glass or other materials with light transmittance and sufficient supporting strength.

The plurality of antenna structures 350 are disposed at intervals on the surface 342 of the inner substrate 340, and their projections in the direction Z (orthogonal projections on the inner substrate 310) overlap with projections of the plurality of antenna structures 320 in the direction Z (orthogonal projections on the inner substrate 310), respectively. The inner substrate 340 is located between the plurality of antenna structures 320 and 350. Additionally, the outer support structure 420 is disposed between the inner substrate 340 and the outer substrate 220. The antenna structures 350 may be surrounded by the outer support structure 420 and exposed through the openings 421. The ranges of the ratio R₁ of the first projected area to the reference area and the ratio R₂ of the second projected area to the reference area are as previously described and will not be reiterated here.

The antenna structures 350 may be similar to the antenna structures 320, and each antenna structure 350 may be a metal plate body such as a patch antenna. The antenna structures 350 may resonate with the antenna structures 320 to increase an operational bandwidth of the antenna device 100B. For example, the antenna device 100B may operate simultaneously in the Ka band and the Ku band (12 GHz-18 GHz). It is worth mentioning that a distance d2 between the surface 312 of the inner substrate 310 and the surface 341 of the inner substrate 340 may range from 0.1 millimeters to 2 millimeters, which is less than a distance d1 between the surface 311 of the inner substrate 310 and the surface 212 of the outer substrate 210, or a distance d1 between the surface 342 of the inner substrate 340 and the surface 221 of the outer substrate 220. It should be noted that the distances d1 and d2 in FIG. 5 are only schematic and are not drawn to scale.

The inner support structure 360 is disposed between the inner substrates 310 and 340. An orthogonal projection of the inner support structure 360 on the inner substrate 310 overlaps at least in part with the orthogonal projections of the outer support structures 410 and 420 on the inner substrate 310. In detail, the inner support structure 360 also has a plurality of openings 361. Orthogonal projections of the openings 361 on the inner substrate 310 also overlap with orthogonal projections of the antenna structures 320 on the inner substrate 310. In other words, the antenna structures 320 may be surrounded by the inner support structure 360 and exposed through the openings 361. Since the orthogonal projections of the outer support structures 410, 420 and the inner support structure 360 on the inner substrate 310 overlap at least partially, the multilayer-structured antenna module 300B can also be firmly supported by the outer support structures 410, 420 and the inner support structure 360.

The material of the inner support structure 360 may be polycarbonate (PC) or polyethylene terephthalate (PET). In particular, a Young's modulus of the inner support structure 360 may range from 2 GPa to 2.5 GPa. Although the Young's modulus of the inner support structure 360 is less than or equal to Young's modulus of the outer support structures 410, or 420, the inner support structure 360 has advantages of high temperature resistance and being less prone to deformation. Therefore, when the inner support structure 360 is assembled with the inner substrates 310 and 340, the positional alignment between the inner support structure 360 and the antenna structures 320 is easier to control, resulting in more precise positional alignment without affecting the operation of the antenna structures 320.

Further, the orthogonal projection of the inner support structure 360 on the inner substrate 310 has a third projected area. A ratio R₃ of the third projected area to the reference area falls within the following range:
37%≤R₃≤(A_{bass}−Aₐₙₜₑₙₙₐ)/A_{bass}

It should be noted that, since the material of the inner support structure 360 possesses specific rigidity, the inner substrates 310 and 340 is avoided from being damaged by lamination stress during the process. Therefore, for example, the minimum limit value of the third projected area is greater than or equal to 37% of the reference area. Further, since the inner support structure 360 also cannot cover the antenna structures 320, for example, the maximum limit value of the third projected area is less than or equal to the reference area minus the antenna area. For example, if a ratio of the antenna area to the reference area is 21%, the ratio R₃ of the third projected area to the reference area may be less than or equal to 79%. In addition, if region reservation for positional alignment errors of the inner support structure 360 is taken into account, the ratio R₃ of the third projected area to the reference area may be less than or equal to 75%.

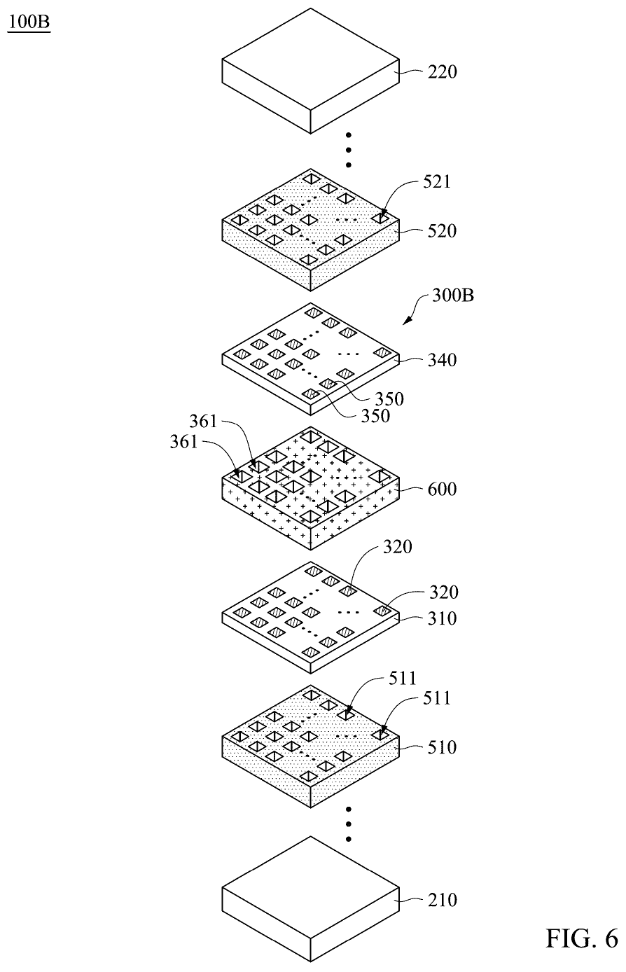

FIG. 6 is a schematic exploded perspective view depicting assembly of the antenna device 100B of FIG. 4. Referring to FIG. 6, during the assembly of the antenna device 100B, the combination of the antenna module 300B is first completed, and then the outer substrates 210, 220, the antenna module 300B, and a plurality of outer support materials 510, 520 undergo a thermal compression process to complete the assembly of the antenna device 100B.

First, an inner support material 600 is patterned to form a plurality of openings 361 on the inner support material 600. Next, the inner support material 600 is disposed between the inner substrates 310 and 340, where the plurality of openings 361 are respectively aligned with the plurality of antenna structures 320. The configurations of the openings 361 respectively correspond to the configurations of the antenna structures 320, and the dimensions of the openings 361 may be slightly larger than those of the openings 511, 521 of the outer support materials 510, 520.

Subsequently, the inner substrates 310, 340 and the inner support material 600 undergo a thermal compression process, so that the inner support material 600 forms the inner support structure 360, thereby completing the assembly of the antenna module 300B. Thereafter, the outer substrates 210, 220, the antenna module 300B, and the plurality of outer support materials 510, 520 are combined to assemble the antenna device 100B. In the antenna device 100B, the outer substrates 210, 220 and the inner substrates 310, 340 may also avoid being damaged by lamination stress during the thermal compression process. Consequently, the manufacturing and assembly yields of the antenna device 100B are thus improved.

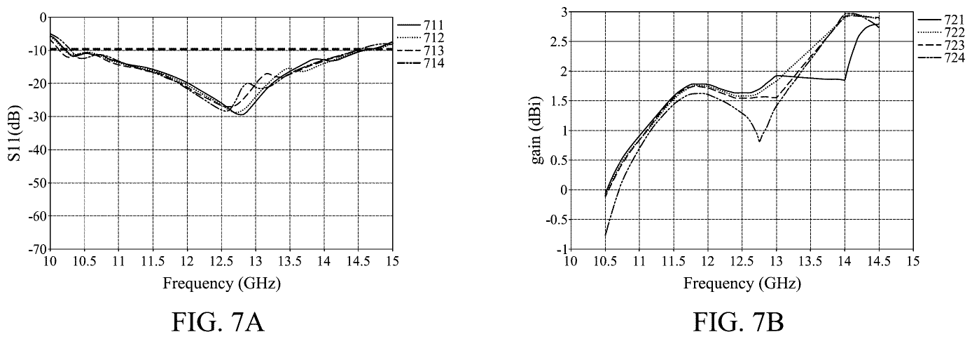

FIGS. 7A and 7B respectively show simulation results of S11 parameters and gains for the antenna device 100B with different dimensions of gaps s1 and s2. Referring to FIG. 5 and FIG. 7A, the vertical axis represents S11 parameter in dB (decibels), and the horizontal axis represents frequency in GHz, where lines 711, 712, 713, 714 respectively represent the S11 parameters when the distances d1 between the surface 311 of the inner substrate 310 and the surface 212 of the outer substrate 210, and between the surface 342 of the inner substrate 340 and the surface 221 of the outer substrate 220 are 3 mm, 4 mm, 5 mm, and 6 mm.

Referring to FIG. 5 and FIG. 7B, the vertical axis represents gain in dBi (dBi represents a decibel compared to an isotropic antenna), and the horizontal axis represents frequency in GHz, where lines 721, 722, 723, 724 respectively represent the gains when the distances d1 between the surface 311 of the inner substrate 310 and the surface 212 of the outer substrate 210, and between the surface 342 of the inner substrate 340 and the surface 221 of the outer substrate 220 are 3 mm, 4 mm, 5 mm, and 6 mm.

As shown in FIGS. 7A and 7B, at the different distances d1, the S11 of the antenna device 100B in the frequency range of 10.7 GHz to 14.5 GHz can be less than −10 dB, thus meeting the bandwidth range of the millimeter wave antenna. However, when the distances d1 is in the range of 4 millimeters to 5 millimeters, the antenna device 100B exhibits an improved gain effect. It can thus be concluded that the presence of air having an appropriate thickness between the antenna module 300B and the outer substrates 210 and 220 indeed enables the antenna device 100B to achieve the effects of good antenna radiation efficiency and reduced loss.

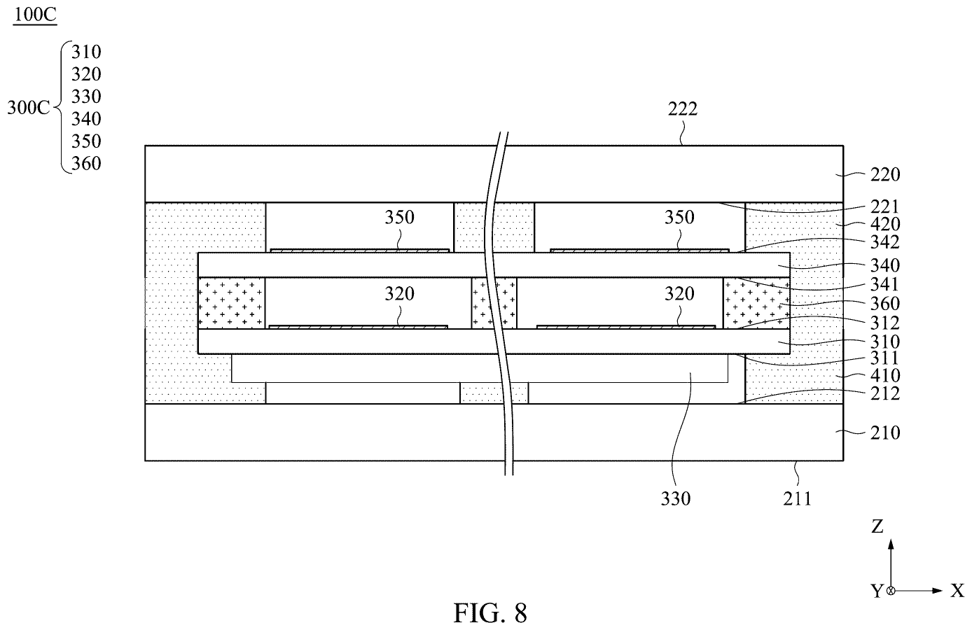

FIG. 8 is a cross-sectional view of the antenna device 100C according to another embodiment of the present disclosure. Referring to FIG. 8, the antenna device 100C of FIG. 8 is similar to the antenna device 100B of FIG. 5. A difference between the two is that the dimensions of inner substrates 310, 340 of the antenna device 100C may be less than those of outer substrates 210, 220. Outer support structures 410 and 420 are partially connected to each other, and the outer support structures 410 and 420 together encapsulate side edges of the antenna module 300C. The areas of surfaces 311, 312, 341, and 342 are the same, and the areas of surfaces 211, 212, 221, and 222 are the same, and the areas of surfaces 311, 312, 341, and 342 are less than those of the surfaces 211, 212, 221, and 222.

Further, although the areas of the surfaces 311, 312, 341, and 342 are less than those of the surfaces 211, 212, 221, and 222, the ranges of a ratio R₁ of a first projected area of an orthogonal projection of the outer support structure 410 on the inner substrate 310 to a reference area of the inner substrate 310, a ratio R₂ of a second projected area of an orthogonal projection of the outer support structure 420 on the inner substrate 310 to the reference area, and a ratio R₃ of a third projected area of an orthogonal projection of an inner support structure 360 on the inner substrate 310 to the reference area remain the same as those of the ratios R₁, R₂, and R₃ in the antenna device 100B. In this way, the outer support structures 410, 420 and the inner support structure 360 can also well support the outer substrates 210, 220 and the inner substrates 310, 340, so that the outer substrates 210, 220 and the inner substrates 310 and 340 may also be avoided from being damaged by lamination stress during the thermal compression process. Consequently, the manufacturing and assembly yields of the antenna device 100C are thus improved.

In summary, in the antenna devices disclosed in the above embodiments, the outer support structures can be disposed between the antenna module and the outer substrates, so that at least one gap exists between the antenna module and the outer substrates to provide air having an appropriate thickness therebetween. In this way, the antenna device can further achieve the effects of wide bandwidth, good antenna radiation efficiency, and reduced loss. Furthermore, through mutual coordination of configurations and material properties of the outer support structures and the inner support structures, the antenna module may be well supported, so that the outer substrate and the inner substrate may be avoided from being damaged by lamination stress in the process, thereby improving the manufacturing and assembly yields of the antenna device.

Although the present disclosure has been disclosed as above in embodiments, the embodiments are not intended to limit the present disclosure, and those of ordinary skill in the art may make some changes and embellishments within the spirit and scope of the present disclosure, therefore, the scope of protection of the present disclosure shall be defined in the attached claim.

What is claimed is:

1. An antenna device, comprising:
a first outer substrate;
a second outer substrate;
an antenna module located between the first outer substrate and the second outer substrate, wherein the antenna module comprises:
a first inner substrate having a surface; and
a first antenna structure disposed on the surface;
a first outer support structure disposed between the antenna module and the first outer substrate, wherein at least one first gap exists between the antenna module and the first outer substrate; and
a second outer support structure disposed between the antenna module and the second outer substrate, wherein at least one second gap exists between the antenna module and the second outer substrate, and
wherein an orthogonal projection of the first outer support structure on the first inner substrate and an orthogonal projection of the second outer support structure on the first inner substrate overlap at least partially.

2. The antenna device according to claim 1, wherein the first outer support structure has a first opening, and the second outer support structure has a second opening, and
wherein the first opening is in communication with the at least one first gap, and an orthogonal projection of the first opening on the first inner substrate overlaps with an orthogonal projection of the first antenna structure on the first inner substrate, and
wherein the second opening is in communication with the at least one second gap, and an orthogonal projection of the second opening on the first inner substrate overlaps with the orthogonal projection of the first antenna structure on the first inner substrate.

3. The antenna device according to claim 1, wherein the orthogonal projection of the first outer support structure on the first inner substrate has a first projected area;
wherein the orthogonal projection of the second outer support structure on the first inner substrate has a second projected area;
wherein the surface has a reference area, and
wherein a ratio of each of the first projected area and the second projected area to the reference area is greater than or equal to 60%.

4. The antenna device according to claim 3, wherein the first antenna structure occupies a region of the surface, and the region has an antenna area;
wherein the ratio of the first projected area to the reference area, and the ratio of the second projected area to the reference area, satisfy ranges, respectively:
R₁≤(A_{bass}−Aₐₙₜₑₙₙₐ)/A_{bass}; and
R₂≤(A_{bass}−Aₐₙₜₑₙₙₐ)/A_{bass}; and
wherein R₁ represents the ratio of the first projected area to the reference area, R₂ represents the ratio of the second projected area to the reference area, A_{bass} represents the reference area, and Aₐₙₜₑₙₙₐ represents the antenna area.

5. The antenna device according to claim 3, wherein the ratio of each of the first projected area and the second projected area to the reference area is less than or equal to 75%.

6. The antenna device according to claim 1, wherein the antenna module further comprises:
a second inner substrate spaced apart from the first inner substrate, wherein the first antenna structure is located between the first inner substrate and the second inner substrate;
a second antenna structure disposed on the second inner substrate, wherein the second inner substrate is located between the first antenna structure and the second antenna structure, and an orthogonal projection of the second antenna structure on the first inner substrate overlaps with an orthogonal projection of the first antenna structure on the first inner substrate; and
an inner support structure disposed between the first inner substrate and the second inner substrate, wherein an orthogonal projection of the inner support structure on the first inner substrate overlaps at least in part with the orthogonal projection of the first outer support structure on the first inner substrate.

7. The antenna device according to claim 6, wherein the orthogonal projection of the inner support structure on the first inner substrate has a third projected area;
wherein the surface has a reference area, and
wherein a ratio of the third projected area to the reference area is greater than or equal to 37%.

8. The antenna device according to claim 7, wherein the first antenna structure occupies a region of the surface, and the region has an antenna area;
wherein the ratio of the third projected area to the reference area satisfies a range:
R₃≤(A_{bass}−Aₐₙₜₑₙₙₐ)/A_{bass}, and
wherein R₃ represents the ratio of the third projected area to the reference area, A_{bass} represents the reference area, and Aₐₙₜₑₙₙₐ represents the antenna area.

9. The antenna device according to claim 6, wherein a Young's modulus of each of the first outer substrate, the second outer substrate, the first inner substrate, and the second inner substrate is greater than a Young's modulus of each of the first outer support structure, the second outer support structure, and the inner support structure, and
wherein the Young's modulus of each of the first outer support structure and the second outer support structure is greater than or equal to the Young's modulus of the inner support structure.

10. The antenna device according to claim 6, wherein a first distance exists between the first inner substrate and the first outer substrate, a second distance exists between the first inner substrate and the second inner substrate, and the first distance is greater than the second distance.

11. A vehicle-mounted antenna device, comprising:
an antenna device, comprising:
a first outer substrate;
a second outer substrate;
an antenna module located between the first outer substrate and the second outer substrate, wherein the antenna module comprises:
a first inner substrate having a surface; and
a first antenna structure disposed on the surface;
a first outer support structure disposed between the antenna module and the first outer substrate, wherein at least one first gap exists between the antenna module and the first outer substrate; and
a second outer support structure disposed between the antenna module and the second outer substrate, wherein at least one second gap exists between the antenna module and the second outer substrate;
wherein an orthogonal projection of the first outer support structure on the first inner substrate and an orthogonal projection of the second outer support structure on the first inner substrate overlap at least partially, and
wherein the antenna device is integrated with a vehicle window of a vehicle body.

12. The vehicle-mounted antenna device according to claim 11, wherein the first outer support structure has a first opening, and the second outer support structure has a second opening;
wherein the first opening is in communication with the at least one first gap, and an orthogonal projection of the first opening on the first inner substrate overlaps with an orthogonal projection of the first antenna structure on the first inner substrate, and
wherein the second opening is in communication with the at least one second gap, and an orthogonal projection of the second opening on the first inner substrate overlaps with the orthogonal projection of the first antenna structure on the first inner substrate.

13. The vehicle-mounted antenna device according to claim 11, wherein the orthogonal projection of the first outer support structure on the first inner substrate has a first projected area;
wherein the orthogonal projection of the second outer support structure on the first inner substrate has a second projected area;
wherein the surface has a reference area, and
wherein a ratio of each of the first projected area and the second projected area to the reference area is greater than or equal to 60%.

14. The vehicle-mounted antenna device according to claim 13, wherein the first antenna structure occupies a region of the surface, and the region has an antenna area;
wherein the ratio of the first projected area to the reference area, and the ratio of the second projected area to the reference area, satisfy ranges, respectively:
R₁≤(A_{bass}−Aₐₙₜₑₙₙₐ)/A_{bass}; and
R₂≤(A_{bass}−Aₐₙₜₑₙₙₐ)/A_{bass}, and
wherein R₁ represents the ratio of the first projected area to the reference area, R₂ represents the ratio of the second projected area to the reference area, A_{bass} represents the reference area, and Aₐₙₜₑₙₙₐ represents the antenna area.

15. The vehicle-mounted antenna device according to claim 13, wherein the ratio of each of the first projected area and the second projected area to the reference area is less than or equal to 75%.

16. The vehicle-mounted antenna device according to claim 11, wherein the antenna module further comprises:
a second inner substrate spaced apart from the first inner substrate, wherein the first antenna structure is located between the first inner substrate and the second inner substrate;
a second antenna structure disposed on the second inner substrate, wherein the second inner substrate is located between the first antenna structure and the second antenna structure, and an orthogonal projection of the second antenna structure on the first inner substrate overlaps with an orthogonal projection of the first antenna structure on the first inner substrate; and
an inner support structure disposed between the first inner substrate and the second inner substrate, wherein an orthogonal projection of the inner support structure on the first inner substrate overlaps at least in part with the orthogonal projection of the first outer support structure on the first inner substrate.

17. The vehicle-mounted antenna device according to claim 16, wherein the orthogonal projection of the inner support structure on the first inner substrate has a third projected area;
wherein the surface has a reference area, and
wherein a ratio of the third projected area to the reference area is greater than or equal to 37%.

18. The vehicle-mounted antenna device according to claim 17, wherein the first antenna structure occupies a region of the surface, and the region has an antenna area;
wherein the ratio of the third projected area to the reference area satisfies a range:
R₃≤(A_{bass}−Aₐₙₜₑₙₙₐ)/A_{bass}, and
wherein R₃ represents the ratio of the third projected area to the reference area, A_{bass} represents the reference area, and Aₐₙₜₑₙₙₐ represents the antenna area.

19. The vehicle-mounted antenna device according to claim 16, wherein a Young's modulus of each of the first outer substrate, the second outer substrate, the first inner substrate, and the second inner substrate is greater than a Young's modulus of each of the first outer support structure, the second outer support structure, and the inner support structure, and
wherein the Young's modulus of each of the first outer support structure and the second outer support structure is greater than or equal to the Young's modulus of the inner support structure.

20. The vehicle-mounted antenna device according to claim 16, wherein a first distance exists between the first inner substrate and the first outer substrate, a second distance exists between the first inner substrate and the second inner substrate, and the first distance is greater than the second distance.
